(19) United States
(12) Patent Application Publication
(10) Pub. No.: US 2024/0338229 A1
(43) Pub. Date: Oct. 10, 2024

(54) METHODS AND APPARATUS FOR BLUEPRINT EXTENSIBILITY VIA PLUGINS

(71) Applicant: VMware LLC, Palo Alto, CA (US)

(72) Inventors: Ventsyslav Raikov, Sofia (BG); Marin Dzhigarov, Sofia (BG); Alexander Dimitrov, Sofia (BG); Atanas Todorov, Sofia (BG); Stoyan Genchev, Sofia (BG); Petar Mitrov, Sofia (BG)

(21) Appl. No.: 18/297,113

(22) Filed: Apr. 7, 2023

(51) Int. Cl. G06F 9/445; G06F 3/0486; G06F 9/54

(52) U.S. Cl. CPC G06F 9/44526; G06F 3/0486; G06F 9/54

(57) ABSTRACT

Methods, apparatus, systems, and articles of manufacture are disclosed. An example system comprises interface circuitry; programmable circuitry; and instructions to program the programmable circuitry to: retrieve metadata associated with a plugin for a cloud resource platform, the plugin to provide a capability to provision a cloud resource of the cloud resource platform; perform a first transformation of the metadata from a first format associated with the plugin to a second format associated with a blueprint service; register the capability into the blueprint service; generate a blueprint including instructions to provision the cloud resource; transform the blueprint from the second format to a third format, the third format at least partially defined by the first format; and provision the cloud resource based on the transformed blueprint.

### FIELD OF THE DISCLOSURE This disclosure relates generally to management of cloud

resources and, more particularly, to methods and apparatus for blueprint extensibility via plugins.

### BACKGROUND

Cloud computing is the delivery of computing resources including storage, processing power, databases, networking, analytics, artificial intelligence, and software applications via a networked data center. Cloud servers can include compute, memory, and/or storage resources to remotely perform services and functions for an organization.

### BRIEF DESCRIPTION OF THE DRAWINGS

FIG. 1 is a block diagram of an example system for

implementing a virtualized environment.

FIG. 2 is a block diagram of example blueprint extensibility circuitry.

FIG. 3 is a flow diagram representative of a process for blueprint extensibility via plugins implemented by the example blueprint extensibility circuitry of FIG. 2.

FIG. 4 is a flowchart representative of example machine readable instructions and/or example operations that may be executed by example processor circuitry to implement the blueprint extensibility circuitry of FIG. 2.

FIG. 5 is a flowchart representative of example machine readable instructions and/or example operations that may be executed by example processor circuitry to implement the blueprint extensibility circuitry of FIG. 2.

FIG. 6 is a block diagram of an example processing platform including processor circuitry structured to execute the example machine readable instructions and/or the example operations of FIG. 4 to implement the blueprint extensibility circuitry of FIG. 2.

FIG. 7 is a block diagram of an example implementation of the processor circuitry of FIG. 4.

FIG. 8 is a block diagram of another example implementation of the processor circuitry of FIG. 4.

FIG. 9 is a block diagram of an example software distribution platform (e.g., one or more servers) to distribute software (e.g., software corresponding to the example machine readable instructions of FIGS. 4-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

In recent years, increasingly large and complex computational workloads (e.g., artificial intelligence, cryptography, scientific simulations, etc.) have been deployed to cloud servers. Such workloads may be associated with a large numbers of virtual machines, containers, and/or other cloud resources, which may be spread across multiple cloud providers. In a virtual infrastructure, such as a multi-cloud management platform, a cloud endpoint is a system and/or a service on which a user can provision resources. The cloud endpoint may be a public cloud resource (e.g., a web service such as Amazon Web Services (AWS), etc.), a virtual appliance (e.g., an external orchestrator appliance, etc.), a private cloud (e.g., hosted by VMware vSphere™, Microsoft Hyper-V™, etc.), etc. A service may have multiple cloud endpoints, such as a catalog service that provides catalog features for a shell/user interface application service to consume. Cloud endpoints may include physical endpoints, virtual endpoints, Internet Protocol Address Management (IPAM) endpoints, etc.

Virtualization technologies can be used for computing, storage, and/or networking. Using virtualization, hardware computing resources and/or other physical resources can be replicated in software. One or more application programming interfaces (APIs) can be implemented to provide access to virtualized resources for users, applications, and/or systems while limiting or masking underlying software and/or hardware structures. Virtualization is increasingly executed in the cloud environment.

Cloud environments can be complex, with a large number of resources to be managed and configured. This can make it difficult for organizations to ensure that their cloud resources are configured correctly and for optimized performance. Cloud management services (e.g., VMware VRealize Automation, VMware Aria Automation, etc.) allow a user to create and/or otherwise deploy machines, applications, and/or services to a cloud infrastructure. Such cloud management services may include a blueprint development and deployment service. A deployment in a cloud-based service is a provisioned instance of a blueprint. As used herein, blueprints are specifications that define machines, applications, and/or services that can be deployed to cloud resources. Blueprints may be developed to target specific cloud vendors and/or resources (e.g., Amazon Web Services (AWS), a virtual appliance such as an external orchestrator appliance, etc., VMware vSphere™, Microsoft Hyper-V™, etc.).

Infrastructure as code (IaC) allows organizations to automate provisioning and configuration of one or more cloud resources. The one or more cloud resources may be distributed across one or more cloud resource providers. IaC also makes it easier to maintain and update cloud infrastructure over time, scale cloud infrastructure up or down as needed, and efficiently respond to changing business needs.

When a blueprint is deployed, a cloud management service (e.g., vRealize Automation) may use a set of rules and policies to automatically provision and configure the necessary resources to create the desired virtual environment. This can include deploying virtual machines from templates, creating networks and storage, and configuring various software components and settings. By using blueprints, organizations can ensure consistency and repeatability in their virtualized environments, while also reducing the amount of effort required for deployment and maintenance of the virtualized environment. Additionally, blueprints can be versioned and shared across teams, making it easier to collaborate and streamline the development and deployment process.

Infrastructure as data (IaD) further simplifies the blueprint deployment process, expanding upon the IaC concept and reducing cloud configuration to data. IaD is a declarative approach to deployment and management of cloud infrastructure. A user can describe a desired state (e.g., in an IDEM (e.g., idempotent) doc and/or an .sls file) without specifying precise actions or steps for how to achieve the state. Then, cloud provisioning circuitry can deploy and/or modify the cloud infrastructure to achieve the described state.

As described herein, a .sls file is a file written in the YAML ain't markup language (YAML) format. The .sls file may contain data and/or instructions for management and configuration of cloud infrastructure, such as that provided by a cloud resource provider through use of an infrastructure data file (e.g., an IDEM doc file, a .sls file, a JSON file, etc.) instead of a script, deployment and maintenance of cloud infrastructure can be simplified. As described herein, an infrastructure data file is a file which includes declarative statements for deployment and management of cloud infrastructure and/or cloud applications. That is, an infrastructure data file includes statements (e.g., declarative statements) which define a desired state for the infrastructure. The infrastructure data file may specify a state for the infrastructure without defining actions or steps for how to achieve it. Instead, the infrastructure data file is provided to a program which can translate the desired state into actions to deploy the cloud resource.

Cloud resource providers continually create new functionalities and features to provide improved capabilities to consumers. The creation of new functionalities places a significant burden on cloud management platform providers, as the cloud management platform must be updated to interoperate with the new capabilities provided by the cloud resource provider. The challenge in implementing such capabilities to cloud management platform providers is worsened as the cloud management platform provider must provide updates for multiple cloud resource providers.

Thus, integrating additional functionalities into a cloud management platform (e.g., VRA) is a difficult and time-consuming process. As such, feature releases and bug fixes for the new features may only be released by cloud management system providers periodically, and customers must wait for the new release to get their features or bug fixes.

Examples disclosed herein allow for simplified utilization of IaD files across existing cloud infrastructure. Some examples retrieve metadata associated with a plugin (e.g., a data file, an Idem doc file, etc.) that provides a resource capability (e.g., a new resource capability, an extension, an increased capability) to a blueprint service, the blueprint service to generate blueprints including instructions for a cloud management system to provision cloud resources. In some examples, a first transformation of metadata associated with a new (e.g., previously not integrated into a cloud management platform) cloud resource is performed, transforming (e.g., translating, converting, etc.) from a first format associated with the plugin to a second format associated with a blueprint service of the cloud management platform. As the metadata (e.g., a cloud template schema and/or associated data, an IDEM doc, etc.) is transformed into a second format (e.g., a format compatible with a blueprint service), the resource may be registered into the blueprint service. The resource may then be used to generate a blueprint including the new resource. Finally, the cloud management platform may perform a second transformation to convert the blueprint from the second format to a third format (e.g., a .sls file) for provisioning the cloud resource based on the transformed blueprint.

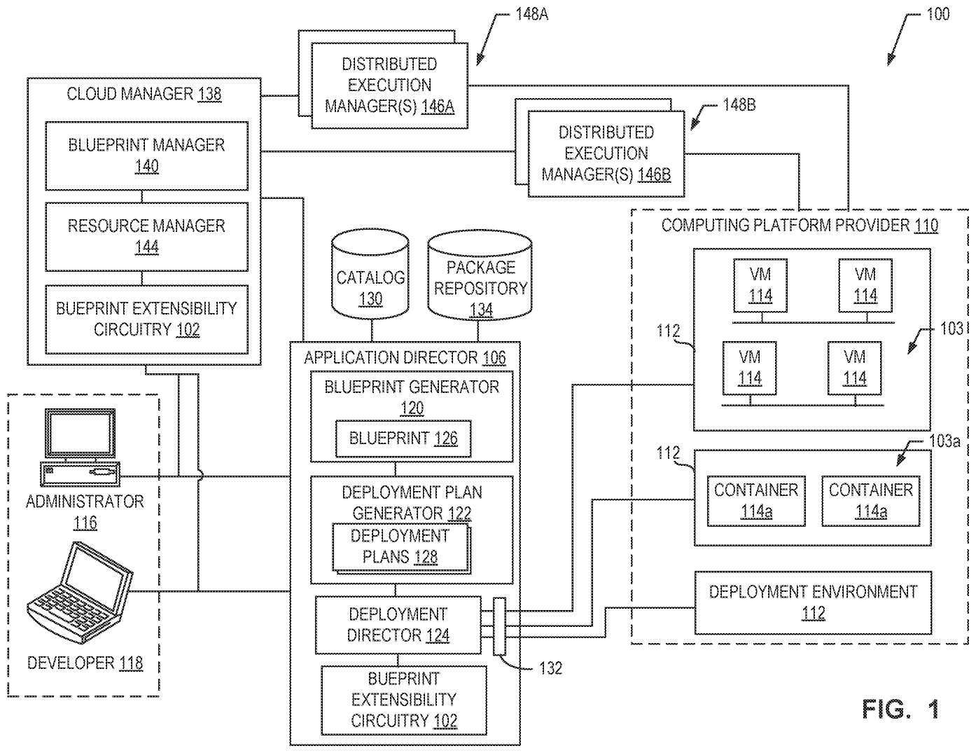

Turning to the figures, FIG. 1 is a block diagram of an example system 100 for implementing a virtualized environment. The example system 100 includes an application director 106 and a cloud manager 138 to manage a computing platform provider 110 as described in more detail below. As described herein, the example system 100 facilitates management of the provider 110 and does not include the provider 110. Alternatively, the provider 110 can be included in the system 100.

The computing platform provider 110 provisions virtual computing resources (e.g., virtual machines, or “VMs,” 114) that may be accessed by users of the computing platform (e.g., users associated with an administrator 116 and/or a developer 118) and/or other programs, software, device. etc.

An example application 103 implemented via the computing platform provider 110 of FIG. 1 includes multiple VMs 114. The example VMs 114 of FIG. 1 provide different functions within the application 103 (e.g., services, portions of the application 103, etc.). One or more of the VMs 114 of the illustrated example are customized by an administrator 116 and/or a developer 118 of the application 103 relative to a stock or out-of-the-box (e.g., commonly available purchased copy) version of the services and/or application components. Additionally, the services executing on the example VMs 114 may have dependencies on other ones of the VMs 114.

As illustrated in FIG. 1, the example computing platform provider 110 may provide multiple deployment environments 112, for example, for development, testing, staging, and/or production of applications. The administrator 116, the developer 118, other programs, and/or other devices may access services from the computing platform provider 110, for example, via REST (Representational State Transfer) APIs (Application Programming Interface) and/or via any other client-server communication protocol. Example implementations of a REST API for cloud and/or other computing services include a vCloud Administrator Center™ (vCAC) and/or vRealize Automation™0 (vRA) API and a vCloud Director™0 API available from VMware, Inc. The example computing platform provider 110 provisions virtual computing resources (e.g., the VMs 114) to provide the deployment environments 112 in which the administrator 116 and/or the developer 118 can deploy multi-tier application(s). One particular example implementation of a deployment environment that may be used to implement the deployment environments 112 of FIG. 1 is vCloud DataCenter cloud computing services available from VMware, Inc.

In some examples disclosed herein, a lighter-weight virtualization is employed by using containers in place of the VMs 114 in the development environment 112. Example containers 114a are software constructs that run on top of a host operating system without the need for a hypervisor or a separate guest operating system. Unlike virtual machines, the containers 114a do not instantiate their own operating systems. Like virtual machines, the containers 114a are logically separate from one another. Numerous containers can run on a single computer, processor system and/or in the same development environment 112. Like virtual machines, the containers 114a can execute instances of applications or programs (e.g., an example application 103a) separate from application/program instances executed by the other containers in the same development environment 112.

The example application director 106 of FIG. 1, which may be running in one or more VMs, orchestrates deployment of multi-tier applications onto one of the example deployment environments 112. As illustrated in FIG. 1, the example application director 106 includes a blueprint generator 120, a deployment plan generator 122, a deployment director 124, and blueprint extensibility circuitry 102.

The example blueprint generator 120 generates a basic blueprint 126 that specifies a logical topology of an application to be deployed. The example basic blueprint 126 generally captures the structure of an application as a collection of application components executing on virtual computing resources. For example, the basic blueprint 126 generated by the example blueprint generator 120 for an online store application may specify a web application (e.g., in the form of a Java web application archive or “WAR” file including dynamic web pages, static web pages, Java servlets, Java classes, and/or other property, configuration and/or resources files that make up a Java web application) executing on an application server (e.g., Apache Tomcat application server) that uses a database (e.g., MongoDB) as a data store. As used herein, the term “application” generally refers to a logical deployment unit, including one or more application packages and their dependent middleware and/or operating systems. Applications may be distributed across multiple VMs. Thus, in the example described above, the term “application” refers to the entire online store application, including application server and database components, rather than just the web application itself. In some instances, the application may include the underlying hardware and/or virtual computing hardware utilized to implement the components.

The example basic blueprint 126 of FIG. 1 may be assembled from items (e.g., templates) from a catalog 130, which is a listing of available virtual computing resources (e.g., VMs, networking, storage, etc.) that may be provisioned from the computing platform provider 110 and available application components (e.g., software services, scripts, code components, application-specific packages) that may be installed on the provisioned virtual computing resources. The example catalog 130 may be pre-populated and/or customized by an administrator 116 (e.g., IT (Information Technology) or system administrator) that enters in specifications, configurations, properties, and/or other details about items in the catalog 130. Based on the application, the example blueprints 126 may define one or more dependencies between application components to indicate an installation order of the application components during deployment. For example, since a load balancer usually cannot be configured until a web application is up and running, the developer 118 may specify a dependency from an Apache service to an application code package.

The example deployment plan generator 122 of the example application director 106 of FIG. 1 generates a deployment plan 128 based on the basic blueprint 126 that includes deployment settings for the basic blueprint 126 (e.g., virtual computing resources' cluster size, CPU, memory, networks, etc.) and an execution plan of tasks having a specified order in which virtual computing resources are provisioned and application components are installed, configured, and started. The example deployment plan 128 of FIG. 1 provides an IT administrator with a process-oriented view of the basic blueprint 126 that indicates discrete actions to be performed to deploy the application. Different deployment plans 128 may be generated from a single basic blueprint 126 to test prototypes (e.g., new application versions), to scale up and/or scale down deployments, and/or to deploy the application to different deployment environments 112 (e.g., testing, staging, production). The deployment plan 128 is separated and distributed as local deployment plans having a series of tasks to be executed by the VMs 114 provisioned from the deployment environment 112. Each VM 114 coordinates execution of each task with a centralized deployment module (e.g., the deployment director 124) to ensure that tasks are executed in an order that complies with dependencies specified in the application blueprint 126.

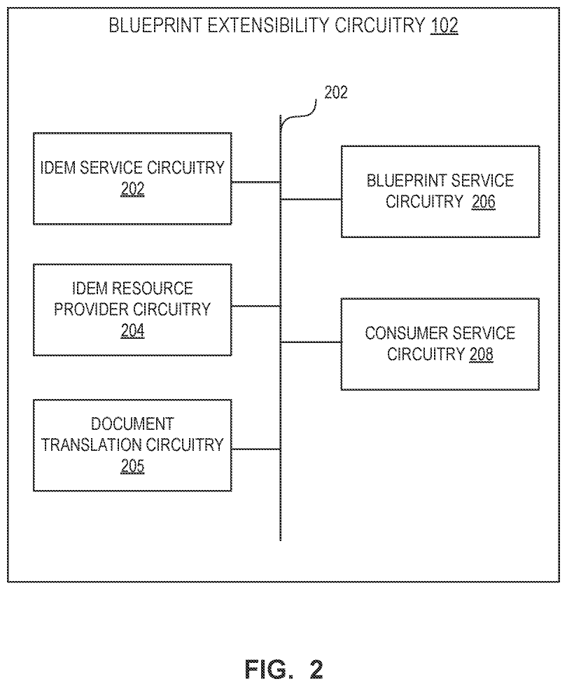

The example deployment director 124 of FIG. 1 executes the deployment plan 128 by communicating with the computing platform provider 110 via an interface 132 to provision and configure the VMs 114 in the deployment environment 112. The example interface 132 of FIG. 1 provides a communication abstraction layer by which the application director 106 may communicate with a heterogeneous mixture of provider 110 and deployment environments 112. The deployment director 124 provides each VM 114 with a series of tasks specific to the receiving VM 114 (herein referred to as a “local deployment plan”). Tasks are executed by the VMs 114 to install, configure, and/or start one or more application components. For example, a task may be a script that, when executed by a VM 114, causes the VM 114 to retrieve and install particular software packages from a central package repository 134. The example deployment director 124 coordinates with the VMs 114 to execute the tasks in an order that observes installation dependencies between VMs 114 according to the deployment plan 128. After the application has been deployed, the application director 106 may be utilized to monitor and/or modify (e.g., scale) the deployment. In general, the example blueprint extensibility circuitry 102 allows automatic discovery and integration of resources and/or plugins to provide additional capabilities to the application director 106, for example. The structure and function of the blueprint extensibility circuitry 102 will be described in further detail in association with FIG. 2.

The example cloud manager 138 of FIG. 1 interacts with the components of the system 100 (e.g., the application director 106 and the provider 110) to facilitate the management of the resources of the provider 110. The example manager 138 includes a blueprint manager 140 to facilitate the creation and management of multi-machine blueprints and a resource manager 144 to reclaim unused cloud resources. The manager 138 may additionally include other components for managing a cloud environment.

The example blueprint manager 140 of the illustrated example manages the creation of multi-machine blueprints that define the attributes of multiple virtual machines as a single group that can be provisioned, deployed, managed, etc. as a single unit. For example, a multi-machine blueprint may include definitions for multiple basic blueprints that make up a service (e.g., an e-commerce provider that includes web servers, application servers, and database servers). A basic blueprint is a definition of policies (e.g., hardware policies, security policies, network policies, etc.) for a single machine (e.g., a single virtual machine such as a web server virtual machine and/or container). Accordingly, the blueprint manager 140 facilitates more efficient management of multiple virtual machines and/or containers than manually managing (e.g., deploying) basic blueprints individually.

The example blueprint manager 140 of FIG. 1 additionally annotates basic blueprints and/or multi-machine blueprints to control how workflows associated with the basic blueprints and/or multi-machine blueprints are executed. As used herein, a workflow is a series of actions and decisions to be executed in a virtual computing platform. The example system 100 may include first and second distributed execution manager(s) (DEM(s)) 146A and 146B to execute workflows, however, such DEMs are not necessary for functioning of the system 100. According to the illustrated example, the first DEM 146A includes a first set of characteristics and is physically located at a first location 148A. The second DEM 146B includes a second set of characteristics and is physically located at a second location 148B. The location and characteristics of a DEM may make that DEM more suitable for performing certain workflows. For example, a DEM may include hardware particularly suited for performance of certain tasks (e.g., high-end calculations), may be located in a desired area (e.g., for compliance with local laws that require certain operations to be physically performed within a country's boundaries), may specify a location or distance to other DEMS for selecting a nearby DEM (e.g., for reducing data transmission latency), etc. Thus, the example blueprint manager 140 annotates basic blueprints and/or multi-machine blueprints with capabilities that can be performed by a DEM that is labeled with the same or similar capabilities. However, in some examples there is no DEM.

The resource manager 144 of the illustrated example facilitates recovery of computing resources of the provider 110 that are no longer being actively utilized. Automated reclamation may include identification, verification and/or reclamation of unused, underutilized, etc. resources to improve the efficiency of the running cloud infrastructure. The system 100 additionally includes the example blueprint extensibility circuitry 102, described in greater detail in association with FIG. 2.

FIG. 2 is a block diagram of blueprint extensibility circuitry to provide additional capabilities to a blueprint management service. The blueprint extensibility circuitry 102 of FIG. 2 may be instantiated (e.g., creating an instance of, bring into being for any length of time, materialize, implement, etc.) by processor circuitry such as a central processing unit executing instructions. Additionally or alternatively, the blueprint extensibility circuitry 102 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers. In this example, the blueprint extensibility circuitry 102 includes example IDEM service circuitry 202, example IDEM resource provider circuitry 204, example document translation circuitry 205, example blueprint service circuitry 206, example blueprint service circuitry 206, and example consumer service circuitry 208.

The example blueprint extensibility circuitry 102 includes the IDEM service circuitry 202. The IDEM service circuitry 202 provides capabilities for one or more plugins that can be used to configure, provision, manage, etc., one or more cloud resources. As defined herein, a plugin (e.g., a cloud plugin, a cloud extension, a cloud add-on, a cloud module, a cloud connector, etc.) is a software component that adds functionality to a cloud computing and/or cloud management platform. Cloud resources are often configured via a cloud resource providers APIs. Thus, in examples disclosed herein, the IDEM service circuitry 202 provides access to one or more cloud resource provider APIs (e.g., and/or other plugin(s)) and provides that information to IDEM resource provider circuitry 204.

For example, the IDEM service circuitry 202 may include a plugin to add support for a new database engine and/or any new cloud resource (e.g., a compute resource, a networking resource, any cloud resource type, etc.) or provide a new management capability for modification of the cloud resources corresponding to the cloud resource. In some examples, cloud plugins can be developed by a cloud resource provider and/or by third-party developers. Then, the resources can be installed and configured through the cloud resource provider's management console (e.g., a command line interface, a graphical console, etc.).

In some examples, plugins are stored by the IDEM service circuitry 202 as a python script. In some examples, data in a first file format (e.g., an IDEM doc, JSON metadata associated with a resource) is transmitted by the IDEM service circuitry 202 to the IDEM resource provider circuitry 204. The first file format may include data that provides capabilities to define a desired state of a portion of one or more cloud infrastructures of one or more cloud service providers. The document translation circuitry 205 may translate the first file format (e.g., IDEM doc) to a second file format (e.g., compatible with blueprint management circuitry and/or a blueprint generation service such as VCT).

The IDEM service circuitry 202 may expose an IDEM doc API which provides metadata of plugins currently installed (e.g., versions, resources they support, schemas of those resources). The IDEM service circuitry 202 may also manage the execution and tracking of IDEM functions (e.g., present, absent and get). In some examples, a user may receive a notification about the progress of their tasks via a messaging bus. In some examples, the IDEM service circuitry 202 may also provide a runtime for the an IDEM command line interface. Additionally or alternatively, the IDEM service circuitry 202 may also expose an API for other services to modify and/or provide any type of IaD file.

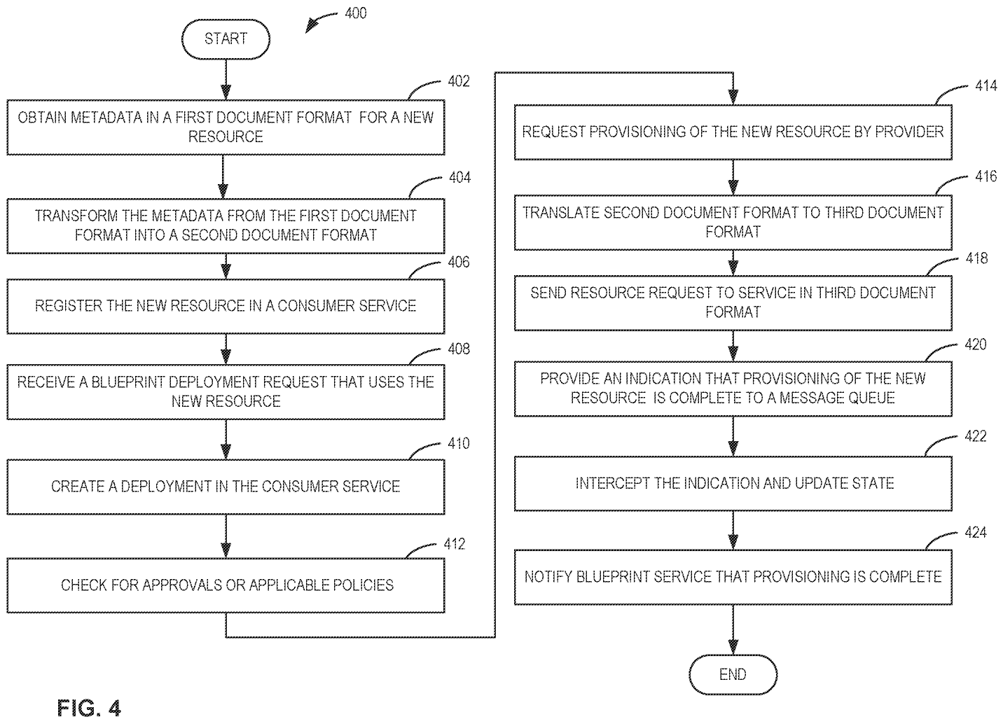

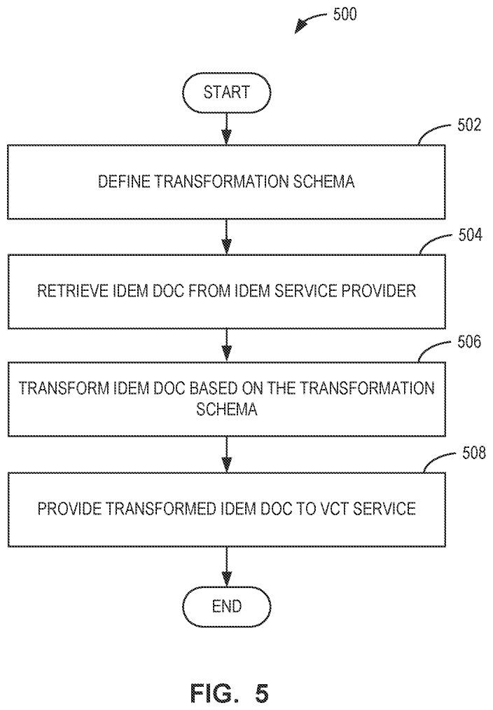

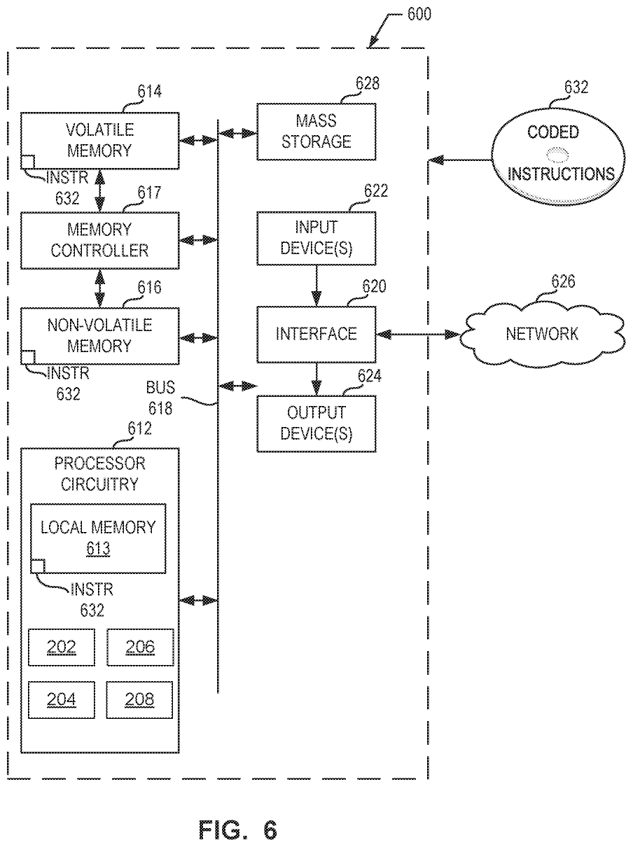

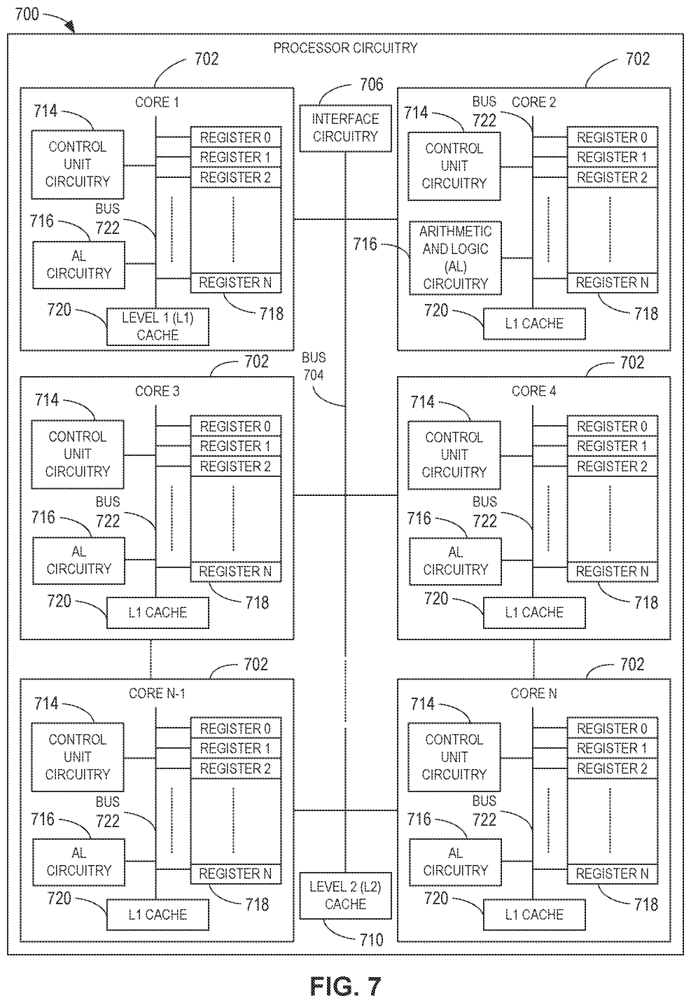

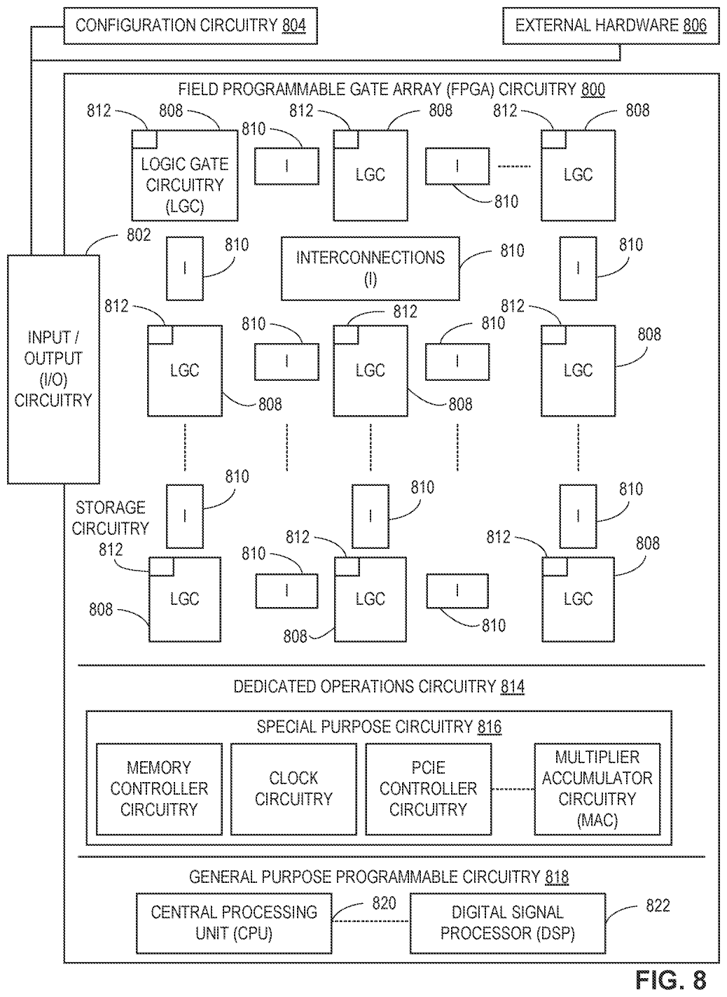

In some examples, the IDEM service circuitry 202 is instantiated by processor circuitry executing blueprint extensibility instructions and/or configured to perform operations such as those represented by the flowcharts of FIGS. 4-5. In some examples, the blueprint extensibility circuitry 102 includes means for providing services. For example, the means for providing services may be implemented by IDEM service circuitry 202. In some examples, the IDEM service circuitry 202 may be instantiated by processor circuitry such as the example processor circuitry 612 of FIG. 6. For instance, the IDEM service circuitry 202 may be instantiated by the example microprocessor 700 of FIG. 7 executing machine executable instructions such as those implemented by at least blocks 406, 408 of FIG. 4. In some examples, the IDEM service circuitry 202 may be instantiated by hardware logic circuitry, which may be implemented by an ASIC, XPU, or the FPGA circuitry 800 of FIG. 8 structured to perform operations corresponding to the machine readable instructions. Additionally or alternatively, the IDEM service circuitry 202 may be instantiated by any other combination of hardware, software, and/or firmware. For example, the IDEM service circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example blueprint extensibility circuitry 102 includes the IDEM resource provider circuitry 204. The IDEM resource provider circuitry 204 may periodically call the IDEM service circuitry 202 (e.g., via an IDEM periodic call) and fetch new and/or any supported plugin(s) (e.g., plugins for a first cloud resource provider, plugins for a second cloud resource provider, etc.), resources for the plugins, and/or schemas for the resources. Then, the IDEM resource provider circuitry 204 may dynamically transform a first schema of the cloud resource (e.g., an IDEM doc to a second schema that is able to be interpreted by the blueprint service circuitry 206 and/or the consumer service circuitry 208 (e.g., a VCT format). In some examples, the document translation circuitry 205 performs a javascript object notation (JSON) to JSON translation with a transformation library (e.g., JOLT). That is, a first schema provided by the IDEM service circuitry 202 may be transformed into a second schema by the document translation circuitry 205.

In some examples, the IDEM resource provider circuitry 204 obtains a plugin that provides metadata in a first schema. As described herein, a cloud template schema is a set of rules and/or guidelines that define the structure and content of a cloud template. The schema may define fields for the cloud template, their data types, and/or the values they can contain. The schema may also define relationships between different fields. Example schemas may be instantiated as javascript object notation (JSON), YAML-based schemas, or extensible markup language (XML) schemas. In some examples, the IDEM resource provider circuitry 204 may provide a schema and the data that is associated with the schema to the document translation circuitry 205 to be translated from a first format (e.g., Idem doc) to a second format (e.g., a VCT template) and/or from the second format (e.g., a VCT template) to a third format (e.g., a .sls file). In some examples, the third format is at least partially defined by the first format. For example, a first format (e.g., an Idem doc) may at least partially define features of the third format (e.g., a .sls file) such as properties of the third format, a type of the third format, parameters of the third format, a structure of the third format, and/or any other features of the third format. In some examples, the first format may be a schema definition for the third format, and therefore fully define the third format.

In some examples, the blueprint extensibility circuitry 102 includes means for providing resources. For example, the means for providing resources may be implemented by IDEM resource provider circuitry 204. In some examples, the IDEM resource provider circuitry 204 may be instantiated by processor circuitry such as the example processor circuitry 612 of FIG. 6. For instance, the IDEM resource provider circuitry 204 may be instantiated by the example microprocessor 700 of FIG. 7 executing machine executable instructions such as those implemented by at least blocks 410, 412 of FIG. 4. In some examples, IDEM resource provider circuitry 204 may be instantiated by hardware logic circuitry, which may be implemented by an ASIC, XPU, or the FPGA circuitry 800 of FIG. 8 structured to perform operations corresponding to the machine readable instructions. Additionally or alternatively, the IDEM resource provider circuitry 204 may be instantiated by any other combination of hardware, software, and/or firmware. For example, the IDEM resource provider circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example blueprint extensibility circuitry 102 includes the document translation circuitry 205. The document translation circuitry 205 may translate a cloud resource plugin from a first schema (e.g., a schema of a cloud resource provider) to a second schema (e.g., a schema of a cloud management provider). Similarly, the document translation circuitry 205 may translate from the second schema (e.g., a schema of a cloud management provider) to a third schema (e.g., a schema for deployment by a cloud resource provider). Such translation may be performed across different resources and/or plugins to accommodate one or more cloud service provider resources (e.g., various cloud environments).

To translate a file from a first schema to a second schema, the document translation circuitry 205 may first identify differences between the second (e.g., target) schema and the first (e.g., original) schema. In some examples, these differences may be analyzed and the first schema may be mapped to the second schema. By generating a mapping between two schemas, the document translation circuitry 205 may perform subsequent translations between the same two schemas without having to subsequently generate the mapping. That is, a single mapping between schemas can facilitate mapping for many documents that conform to the single schema.

To translate a file from a second schema to a third schema, the document translation circuitry 205 may first identify differences between the third (e.g., target) schema and the second (e.g., original) schema. In some examples, these differences may be analyzed and the third schema may be mapped to the second schema. By generating a mapping between two schemas, the document translation circuitry 205 may perform subsequent translations between the two schemas without having to subsequently generate the mapping. That is, a single mapping between schemas can facilitate mapping for many documents that conform to the single schema.

For example, the document translation circuitry 205 may identify fields and/or data types in the original schema and map them to the corresponding fields and data types in the target schema. For example, naming, syntax, and data types may be different between the two schemas, yet able to be mapped consistently from the original schema (e.g., the first schema) to the target schema (e.g., the second schema). Accordingly, a first schema may be modified by, for example, changing data types, adding a data field, removing unnecessary data, etc.

In some examples, the blueprint extensibility circuitry 102 includes means for translating a document from a first schema to a second schema. For example, the means for translating may be implemented by the document translation circuitry 205. In some examples, the document translation circuitry 205 may be instantiated by processor circuitry such as the example processor circuitry 612 of FIG. 6. For instance, document translation circuitry 205 may be instantiated by the example microprocessor 700 of FIG. 7 executing machine executable instructions such as those implemented by at least blocks 404, 416 of FIG. 4. In some examples, the document translation circuitry 205 may be instantiated by hardware logic circuitry, which may be implemented by an ASIC, XPU, or the FPGA circuitry 800 of FIG. 8 structured to perform operations corresponding to the machine readable instructions. Additionally or alternatively, the document translation circuitry 205 may be instantiated by any other combination of hardware, software, and/or firmware. For example, the document translation circuitry 205 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example blueprint extensibility circuitry 102 includes the example blueprint service circuitry 206. The blueprint service circuitry 206 allows for selection of blueprints, generation of blueprints, modification of blueprints, execution of blueprints, etc. In some examples, the blueprint service circuitry 206 receives a request (e.g., via a user, via an API, a programmatic request, etc.) for a blueprint. In some examples, the blueprint service circuitry 206 provides a selection of blueprints that can be customized and/or modified by a user. For example, the blueprint service circuitry 206 can provide a blueprint that can be used to begin provisioning of a cloud resource with various properties (e.g., disk size, network resources, application dependencies). Furthermore, the blueprint service circuitry 206 can associate subsequent actions with deployment of a cloud resource (e.g., configuring a virtual machine, communicating with another cloud resource, initiating provisioning of another cloud resource, etc.).

The blueprint service circuitry 206 also may provide a drag-and-drop interface for a user to create and modify a blueprint using a graphical user interface. In some examples, the drag-and-drop functionality allows a user to combine and/or modify a blueprint with pre-defined components (e.g., compute resources, storage resources, network resources, etc.). With the integration of IDEM service circuitry 202 and the IDEM resource provider circuitry 204, blueprints can be modified with resources that are, for example, provided based on a first format (e.g., an IDEM doc). This can allow new resources (e.g., previously not registered with the blueprint service circuitry 206) to be used in the generation of blueprints. Furthermore, such blueprints can be modified with preexisting features and/or combined/linked with other blueprints to create resources (e.g., virtual resources) that provide further capabilities than any single cloud resource alone. For example, an IDEM plugin provided by the IDEM service circuitry 202 from a first provider may be combined with an IDEM plugin for a second provider, wherein the first provider includes at least one of a first processing capability, a first memory capability, and/or a first networking capability, and wherein the second provider includes at least one of a first memory capability, and/or a first networking capability, at least some of the capabilities of the first and second provider combined and presented by the blueprint service circuitry 206 as a single cloud resource. Additionally or alternatively, a single cloud resource that is provided by the IDEM service circuitry 202 and/or IDEM resource provider circuitry 204 may split the single cloud resource across a plurality of virtual resources and/or blueprints of the blueprint service circuitry 206.

The blueprint service circuitry 206 may create a deployment of a blueprint in the consumer service circuitry 208. For example, a blueprint for a new service may be generated and then deployed to the consumer service circuitry 208. In some examples, the blueprint service circuitry 206 may perform various tasks such as version management of blueprints, provide blueprint modification options, etc.

In some examples, the blueprint extensibility circuitry 102 includes means for generating blueprints. For example, the means for generating blueprints may be implemented by blueprint service circuitry 206. In some examples, the blueprint service circuitry 206 may be instantiated by processor circuitry such as the example processor circuitry 612 of FIG. 6. For instance, the blueprint service circuitry 206 may be instantiated by the example microprocessor 700 of FIG. 7 executing machine executable instructions such as those implemented by at least blocks 408 and 410 of FIG. 4. In some examples, the blueprint service circuitry 206 may be instantiated by hardware logic circuitry, which may be implemented by an ASIC, XPU, or the FPGA circuitry 800 of FIG. 8 structured to perform operations corresponding to the machine readable instructions. Additionally or alternatively, the blueprint service circuitry 206 may be instantiated by any other combination of hardware, software, and/or firmware. For example, the blueprint service circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example blueprint extensibility circuitry 102 includes the consumer service circuitry 208. The consumer service circuitry 208 may provide services to a consumer (e.g., new services instantiated via a blueprint) and/or present various analytic/management data about the resources to the consumer. For example, the consumer service circuitry 208 may perform various configuration and/or bootstrapping operations to instantiate the blueprint provided by the blueprint service circuitry 206.

In some examples, the consumer service circuitry 208 may provide analytics for the services provided by the IDEM resource provider circuitry 204 and/or IDEM service circuitry 202. For example, a price dashboard may provide analytics about IDEM cloud resources to a consumer. In some examples, the consumer service circuitry 208 may provide an analysis of how a new cloud resource provided by the blueprint service circuitry 206 and/or consumer service circuitry 208 will affect costs of a cloud infrastructure.

In some examples, the consumer service circuitry 208 may provide governance capabilities associated with the resources provided by the IDEM service circuitry 202 and/or IDEM resource provider circuitry 204 (e.g., or other instantiated blueprints). For example, the consumer service circuitry 208 may determine if any approvals are applicable. If so, the approval (e.g., for an IDEM resource) may be sent through an approval workflow, which can be customized to meet an organization's requirements.

In some examples, the blueprint extensibility circuitry 102 includes means for providing resources to a consumer. For example, the means for providing resources to a consumer may be implemented by consumer service circuitry 208. In some examples, the consumer service circuitry 208 may be instantiated by processor circuitry such as the example processor circuitry 612 of FIG. 6. For instance, the consumer service circuitry 208 may be instantiated by the example microprocessor 700 of FIG. 7 executing machine executable instructions such as those implemented by at least blocks 410 of FIG. 4. In some examples, the consumer service circuitry 208 may be instantiated by hardware logic circuitry, which may be implemented by an ASIC, XPU, or the FPGA circuitry 800 of FIG. 8 structured to perform operations corresponding to the machine readable instructions. Additionally or alternatively, the consumer service circuitry 208 may be instantiated by any other combination of hardware, software, and/or firmware. For example, the consumer service circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example blueprint extensibility circuitry 102 also includes the example bus 202. The example bus 202 may facilitate communication between one or more of the IDEM service circuitry 202, the IDEM resource provider circuitry 204, the document translation circuitry 205, the blueprint service circuitry 206, and/or the consumer service circuitry 208. The bus 202 may be implemented in circuitry and/or may be a virtual bus.

While an example manner of implementing the blueprint extensibility circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example IDEM service circuitry 202, the IDEM resource provider circuitry 204, the document translation circuitry 205, the blueprint service circuitry 206, and/or the consumer service circuitry 208, and/or, more generally, the example blueprint extensibility circuitry 102 of FIG. 1, may be implemented by hardware alone or by hardware in combination with software and/or firmware. Thus, for example, any of the IDEM service circuitry 202, the IDEM resource provider circuitry 204, the document translation circuitry 205, the blueprint service circuitry 206, and/or the consumer service circuitry 208, and/or, more generally, the example blueprint extensibility circuitry 102, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example blueprint extensibility circuitry 102 of FIG. 1 may include one or more elements, processes, and/or devices in addition to, or instead of, those illustrated in FIG. 2, and/or may include more than one of any or all of the illustrated elements, processes and devices.

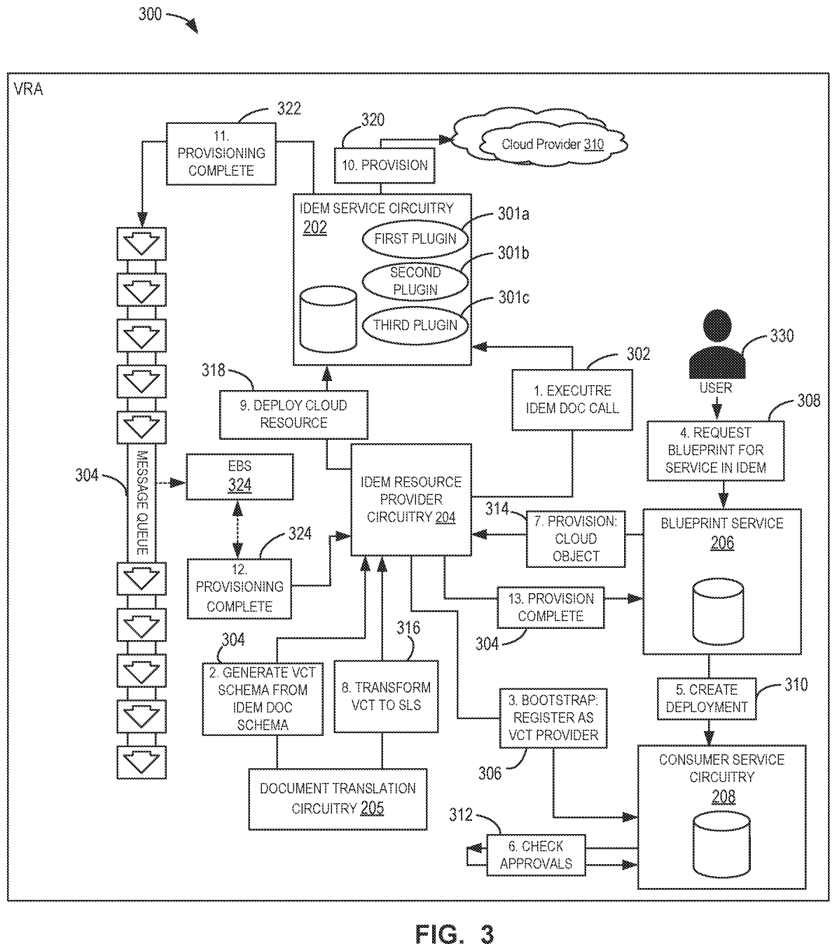

FIG. 3 is an illustration of an example system 300 for blueprint extensibility via plugins. The example system 300 is a cloud management platform system (e.g., VMware vRealize Automation (VRA)) which provides capabilities to create and manage cloud resources. Furthermore, the system 300 includes the blueprint extensibility circuitry 102, as the system 300 includes the IDEM service circuitry 202, the IDEM resource provider circuitry 204, the document translation circuitry 205, the blueprint service circuitry 206, and the consumer service circuitry 208. In some examples, a first schema (e.g., IDEM doc) is transformed to a second schema (e.g., VCT) by the document translation circuitry 205 to facilitate generation of a blueprint by the blueprint service circuitry 206 and/or the consumer service circuitry 208. For example, the first file format (e.g., IDEM doc) may include metadata about resources provided by a cloud resource provider. The resources may be transformed to the second format (e.g., VCT) for registration by a cloud management and/or blueprint generation service. To facilitate provisioning of the resources, the document translation circuitry 205 may perform a second transformation to translate the second format to a third format (e.g., a .sls file) that is suitable for and/or compatible with a cloud resource provider for provisioning. Thus, the system 300 is an automation tool for the cloud (e.g., a private cloud, a public cloud, a hybrid cloud, etc.).

The system 300 provides support for hybrid cloud models (e.g., public and private cloud integration). For example, a data file (e.g., plain text or any type of structured/unstructured data) may be used to describe a desired infrastructure, which is stored in an online server. In some examples, multiple data files are generated by cloud resource providers and/or consumers and the data files are retrieved by the system 300 for integration into the blueprint service circuitry 206. Some examples interoperate with a cloud automation system (e.g., IDEM) and allow for efficient generation and integration (e.g., integration via the document translation circuitry 205 building of plugins that represent resources in public clouds) into the blueprint service circuitry 206 and consumer service circuitry 208. In this way, the system 300 facilitates cloud resource ease of maintenance, ease of discovery, and ease of use.

The system 300 can be understood in terms of microservices. For example, the IDEM service circuitry 202, the IDEM resource provider circuitry 204, the document translation circuitry 205, the blueprint service circuitry 206, the consumer service circuitry 208, the EBS 324, etc., may be microservices. In some examples, the system 300 includes one or more microservices that allow a cloud provider to register their endpoints and the resources (e.g., and/or operations on them) dynamically based on calling representational state transfer (REST) application programming interfaces (APIs). In some examples, the IDEM service circuitry 202 and/or the IDEM resource provider circuitry 204 are new microservices that may be integrated into an existing cloud management platform. Thus, resources and operations supported by the IDEM service circuitry 202 can appear in the blueprint service circuitry 206, for example. That is, the document translation circuitry 205 can translate a first IaD file (e.g., for provisioning a cloud resource) from a first format that is not natively compatible with the blueprint service circuitry 206 and present IaD capabilities on a design canvas, enabling customers to use new resources in a blueprint (e.g., a template of the blueprint service circuitry 206), provision the new resources, and utilize the consumer service circuitry 208 features such as governance, lifecycle management and extensibility.

In some examples, the IDEM service circuitry 202 includes one or more plugins (e.g., a first plugin 304, a second plugin 306, and a third plugin 306). The IDEM service circuitry 202 can provide metadata (e.g., a schema of the first plugin 304, the second plugin 306, and/or the third plugin 306) which may include version information. In some examples, the IDEM service circuitry 202, the IDEM resource provider circuitry 204, the document translation circuitry 205, the blueprint service circuitry 206, and/or the consumer service circuitry 208 may be idempotent microservices. As described herein, idempotence is any function that can be executed several times without changing the final result beyond its first iteration. For example, the blueprint service circuitry 206 and/or the consumer service circuitry 208 may support operations such as “present,” “absent,” and “get.”

As shown in the system 300, the IDEM resource provider circuitry 204 periodically calls the IDEM service circuitry 202 (e.g., an IDEM doc API) and fetches supported plugins (e.g., the first plugin 304, the second plugin 306, the third plugin 308) along with the resources and their schemas. Then, the IDEM resource provider circuitry 204 may dynamically transform the schemas of the resources to a format of the blueprint service circuitry 206.

Thus, the system 300, via the IDEM service circuitry 202, can bridge the gap between a cloud resource provider and a cloud management provider, allowing for automatic discovery of resources and plugins that are registered in the IDEM service circuitry 202. Based on the metadata that is provided, the IDEM resource provider circuitry 204 can automatically register (e.g., without writing custom code to translate each new resource) the resources and/or plugins. Thus, with the system 300, a user 330 can easily drag-and-drop resources of the IDEM service circuitry 202 to provision a blueprint and manage the blueprint.

At block 302, the IDEM resource provider circuitry 204 (e.g., via an API from the IDEM service circuitry 202) obtains metadata for at least one resource that is available in the IDEM plugins registered in the IDEM service circuitry 202. For example, there may be a first plugin 301a, a second plugin 301b, a third plugin 301c. Then, the resources provided by the plugins, their structure (e.g., the metadata that describes different properties), can be provided to the document translation circuitry 205. This can be done periodically, such that when new versions of the plugins are detected, the new versions of the plugins can be installed in the IDEM service. In this way, the blueprint service circuitry 206 can stay up-to-date and provide capabilities for recent and/or future resources provided by a cloud resource provider.

At block 304, the example IDEM resource provider circuitry 204 provides the resource (e.g., in a first schema) and translates the IDEM doc metadata into a language that the consumer service circuitry 208 can utilize. Then, at block 306, the IDEM resource provider circuitry 204 and/or consumer service circuitry 208 can register the new resources in the consumer service circuitry 208.

At block 308, the user 330 creates and requests deployment of a blueprint (e.g., request an S3 bucket provided by the IDEM service). For example, when a blueprint type is registered, resources and/or capabilities may appear on a blueprint canvas of the blueprint service circuitry 206. Thus, the user 330 can utilize the resources provided by the first, second, and/or third plugins 301a, 301b, and/or 301c, and register such capabilities (e.g., provided by the plugin) to the blueprint. For example, there may be a list of boxes that represent resources that allow drag and drop functionality onto a blueprint. In some examples, a user can create and/or design a blueprint, save the blueprint, and then later request the blueprint. When the user submits a request to deploy a blueprint with resources from the plugins 301a-c, the blueprint service circuitry 206 may call the IDEM resource provider circuitry 204 with a resource payload. The transformation from VCT to an IDEM schema (e.g., .sls format) can be done using operations such as “present” (e.g., for most operations) “absent” (e.g., in case of deletion). The transformation may be provided to IDEM via an application programming interface (e.g., a GraphQL API) and a task identifier may be returned as response from IDEM. The task identifier may be used for tracking, communication, and/or notification between services.

At block 310, the blueprint service 206 creates a deployment in the consumer service 208. In some examples, this may be performed by the cloud management platform (e.g., handled by VRA). At block 312, the consumer service 208 can check for any approvals or other policies.

At block 314, the blueprint service 206 returns to the IDEM resource provider 204 (e.g., resource obtained from the IDEM resource provider 204), and requests the resource to be provisioned. At block 316, the IDEM resources provider 204 performs a second transformation. The IDEM resource provider 204 can be analogized to an interpreter between a first language (e.g., of VCT) and the language of IDEM service (e.g., .sls). At block 316, the provisioning request to the IDEM resource provider circuitry 204 is prepared for dispatch, and the provisioning request is to be translated from the language of the VCT service to SLS (e.g., the language of the IDEM service 202). In some examples, the second transformation at block 316 is a substantially one-to-one translation because of the way that the first document format (e.g., IDEM doc) translates metadata (e.g., name and other properties) into the second (e.g., VCT) language. Thus, the second transformation (e.g., from VCT to .sls) may be a substantially one-to-one translation. In some examples, such a process is data driven by plugins, so no custom code is required for this specific transformation. Thus, in some examples, a first translation from a first file format (e.g.,. IDEM doc) to the second file format (e.g., VCT) and a second transformation (e.g., from VCT to .sls) are data driven and do not require developers to write custom code.

At block 318, the resource request is sent to the IDEM service 202. Then, at block 320 the IDEM service provisions the resources (e.g., cloud storage). At block 322, the IDEM service 202, when the provisioning is complete, provides an indication that the provisioning is complete to a message queue.

At block 324, the event broker subscriptions (EBS) 324 listens for the indication on a message queue (e.g., for a specific topic). If and when the EBS, service 324 may intercept the provision completed request, the state of the IDEM resource provider 204 can be updated (e.g., updating VRA). At block 324, the example IDEM resource provider circuitry 204 notifies the blueprint service 206 that the provisioning is complete.

A flowchart representative of example machine readable instructions, which may be executed to configure processor circuitry to implement the blueprint extensibility circuitry 102 of FIG. 2, is shown in FIG. 3. The machine readable instructions may be one or more executable programs or portion(s) of an executable program for execution by processor circuitry, such as the processor circuitry 612 shown in the example processor platform 600 discussed below in connection with FIG. 6 and/or the example processor circuitry discussed below in connection with FIGS. 7 and/or 8. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 3, many other methods of implementing the example blueprint extensibility circuitry 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 to generate a VCT schema from an IDEM doc schema. At block 402, the IDEM service circuitry 202 obtains metadata in a first document format (e.g., IDEM doc) for a new resource. At block 404, the example document translation circuitry 205 transforms the metadata from the first document format (e.g., IDEM doc) into a second document format (e.g., VCT document format). At block 406, the IDEM resource provider circuitry 204 registers the new resource in a consumer service (e.g., a VCT consumer service).

At block 408, the example blueprint service circuitry 206 obtains a blueprint deployment request that uses the new resource. At block 410, the new resource (e.g., via the transformed document) is deployed in the consumer service circuitry 208. At block 412, the example consumer service circuitry 208 checks for approvals and/or applicable policies. At block 414, the example IDEM resource provider circuitry 204 requests provisioning of the new resource by IDEM provider. At block 416, the example document translation circuitry 205 performs a second transformation to translate the second document format to a third document format (e.g., VCT transformed to .sls).

At block 418, the IDEM resource provider circuitry 204 sends a resource request to the IDEM service (e.g., in the third document format, in a .sls file). At block 420, the IDEM service circuitry 202 provides an indication that provisioning of the new resource is complete to a message queue. At block 422, the EBS 324 intercepts the indication and updates the state of the IDEM resource provider circuitry 204. At block 424, the IDEM resource provider circuitry 204 notifies the blueprint service that provisioning is complete.

FIG. 5 is a flowchart representative of example machine readable instructions and/or example operations 500 to generate a second schema (e.g., a VCT schema) from a first schema (e.g., an IDEM doc schema). At block 502 the document translation circuitry 205 performs a transformation. The transformation may be performed based on a translation schema (e.g., a JSON to JSON transformation schema) that allows a structured data file (e.g., IDEM doc, a first JSON file, etc.) to be translated into a second format (e.g., providing an output that VCT can interpret). Thus, for each new IDEM plugin and each new IDEM resource, a single transformation schema (e.g., written only once) automatically transforms the first document format (e.g., describing a new IDEM resource) into a second document format (e.g., a VCT format).

At block 504, IDEM service circuitry 202 obtains data in a first schema (e.g., IDEM doc). At block 506, the document translation circuitry 205 transforms the first schema with a JSON to JSON (e.g., “JOLT”) transformation. In some examples, transformation is performed by an open source tool that allows transformation from JSON to XML, JSON to YAML, from JSON to JSON, etc. The document translation circuitry 205 applies a transformation based on a schema from a first JSON document to a second JSON document. Although the operations 500 describe a first transformation (e.g., from IDEM doc to VCT), a similar process may be used to perform subsequent transformations (e.g., from a second document format to a third document format).

FIG. 6 is a block diagram of an example processor platform 600 structured to execute and/or instantiate the machine readable instructions and/or the operations of FIGS. 3-5 to implement the blueprint extensibility circuitry 102 of FIG. 2. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 600 of the illustrated example includes processor circuitry 612. The processor circuitry 612 of the illustrated example is hardware. For example, the processor circuitry 612 can be implemented by one or more integrated circuits, logic circuits, FPGAs, microprocessors, CPUs, GPUs, DSPs, and/or microcontrollers from any desired family or manufacturer. The processor circuitry 612 may be implemented by one or more semiconductor based (e.g., silicon based) devices. In this example, the processor circuitry 612 implements IDEM service circuitry 202, the IDEM resource provider circuitry 204, the document translation circuitry 205, the blueprint service circuitry 206, and/or a the consumer service circuitry 208.

The processor circuitry 612 of the illustrated example includes a local memory 613 (e.g., a cache, registers, etc.). The processor circuitry 612 of the illustrated example is in communication with a main memory including a volatile memory 614 and a non-volatile memory 616 by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617.

The processor platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user to enter data and/or commands into the processor circuitry 612. The input device(s) 622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 600 of the illustrated example also includes one or more mass storage devices 628 to store software and/or data. Examples of such mass storage devices 628 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 632, which may be implemented by the machine readable instructions of FIGS. 3-5, may be stored in the mass storage device 628, in the volatile memory 614, in the non-volatile memory 616, and/or on a removable non-transitory computer readable storage medium such as a CD or DVD.

FIG. 7 is a block diagram of an example implementation of the processor circuitry 612 of FIG. 6. In this example, the processor circuitry 612 of FIG. 6 is implemented by a microprocessor 700. For example, the microprocessor 700 may be a general purpose microprocessor (e.g., general purpose microprocessor circuitry). The microprocessor 700 executes some or all of the machine readable instructions of the flowchart of FIGS. 3-5 to effectively instantiate the blueprint extensibility circuitry 102 as logic circuits to perform the operations corresponding to those machine readable instructions. In some such examples, the blueprint extensibility circuitry 102 is instantiated by the hardware circuits of the microprocessor 700 in combination with the instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowchart of FIGS. 3-5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating point operations. In yet other examples, the AL circuitry 716 may include first AL circuitry that performs integer based operations and second AL circuitry that performs floating point operations. In some examples, the AL circuitry 716 may be referred to as an Arithmetic Logic Unit (ALU). The registers 718 are semiconductor-based structures to store data and/or instructions such as results of one or more of the operations performed by the AL circuitry 716 of the corresponding core 702. For example, the registers 718 may include vector register(s), SIMD register(s), general purpose register(s), flag register(s), segment register(s), machine specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure including distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 8 is a block diagram of another example implementation of the processor circuitry 612 of FIG. 6. In this example, the processor circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the machine readable instructions in hardware and, thus, can often execute the operations faster than they could be performed by a general purpose microprocessor executing the corresponding software.

More specifically, in contrast to the microprocessor 700 of FIG. 7 described above (which is a general purpose device that may be programmed to execute some or all of the machine readable instructions represented by the flowchart of FIGS. 3-5 but whose interconnections and logic circuitry are fixed once fabricated), the FPGA circuitry 800 of the example of FIG. 8 includes interconnections and logic circuitry that may be configured and/or interconnected in different ways after fabrication to instantiate, for example, some or all of the machine readable instructions represented by the flowchart of FIGS. 3-5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the software represented by the flowchart of FIGS. 3-5. As such, the FPGA circuitry 800 may be structured to effectively instantiate some or all of the machine readable instructions of the flowchart of FIGS. 3-5 as dedicated logic circuits to perform the operations corresponding to those software instructions in a dedicated manner analogous to an ASIC. Therefore, the FPGA circuitry 800 may perform the operations corresponding to the some or all of the machine readable instructions of FIGS. 3-5 faster than the general purpose microprocessor can execute the same.

In the example of FIG. 8, the FPGA circuitry 800 is structured to be programmed (and/or reprogrammed one or more times) by an end user by a hardware description language (HDL) such as Verilog. The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain machine readable instructions to configure the FPGA circuitry 800, or portion(s) thereof. In some such examples, the configuration circuitry 804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 806 may be implemented by external hardware circuitry. For example, the external hardware 806 may be implemented by the microprocessor 700 of FIG. 7. The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations that may correspond to at least some of the machine readable instructions of FIGS. 3-5 and/or other desired operations. The logic gate circuitry 808 shown in FIG. 8 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example Dedicated Operations Circuitry 814. In this example, the Dedicated Operations Circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the processor circuitry 612 of FIG. 6, many other approaches are contemplated. For example, as mentioned above, modern FPGA circuitry may include an on-board CPU, such as one or more of the example CPU 820 of FIG. 8. Therefore, the processor circuitry 612 of FIG. 6 may additionally be implemented by combining the example microprocessor 700 of FIG. 7 and the example FPGA circuitry 800 of FIG. 8. In some such hybrid examples, a first portion of the machine readable instructions represented by the flowchart of FIGS. 3-5 may be executed by one or more of the cores 702 of FIG. 7, a second portion of the machine readable instructions represented by the flowchart of FIGS. 3-5 may be executed by the FPGA circuitry 800 of FIG. 8, and/or a third portion of the machine readable instructions represented by the flowchart of FIGS. 3-5 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the processor circuitry 612 of FIG. 6, which may be in one or more packages. For example, the XPU may include a CPU in one package, a DSP in another package, a GPU in yet another package, and an FPGA in still yet another package.

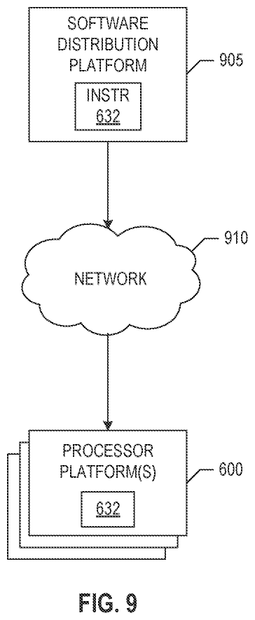

A block diagram illustrating an example software distribution platform 905 to distribute software such as the example machine readable instructions 932 of FIG. 9 to hardware devices owned and/or operated by third parties is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 932, which may correspond to the example machine readable instructions 432 of FIGS. 3-5, as described above. The one or more servers of the example software distribution platform 905 are in communication with an example network 910, which may correspond to any one or more of the

Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 905. For example, the software, which may correspond to the example machine readable instructions 400 of FIG. 4, may be downloaded to the example processor platform 600, which is to execute the machine readable instructions 932 to implement the blueprint extensibility circuitry 102. In some examples, one or more servers of the software distribution platform 905 periodically offer, transmit, and/or force updates to the software (e.g., the example machine readable instructions 932 of FIG. 9) to ensure improvements, patches, updates, etc., are distributed and applied to the software at the end user devices.

From the foregoing, it will be appreciated that example systems, methods, apparatus, and articles of manufacture have been disclosed that provide blueprint extensibility via plugins. Disclosed systems, methods, apparatus, and articles of manufacture improve the efficiency of using a computing device by allowing a plugin built by a cloud management platform provider or a cloud resource to quickly autogenerate a significant portion of infrastructure automatically (e.g., automatic generation of 60% of deployment code). Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to perform blueprint extensibility via plugins are disclosed herein. Further examples and combinations thereof include the following:

Example 1 includes a system comprising interface circuitry, programmable circuitry, and instructions to program the programmable circuitry to retrieve metadata associated with a plugin for a cloud resource platform, the plugin to provide a capability to provision a cloud resource of the cloud resource platform, transform the metadata from a first format associated with the plugin to a second format associated with a blueprint service, register the capability into the blueprint service, generate a blueprint including instructions to provision the cloud resource, transform the blueprint from the second format to a third format, the third format at least partially defined by the first format, and provision the cloud resource based on the transformed blueprint.

Example 2 includes the system of example 1, wherein the programmable circuitry is to retrieve the metadata via an API call at periodic intervals to obtain new versions of the plugin.

Example 3 includes the system of example 1, wherein the first transformation is a javascript object notation (JSON) to JSON transformation.

Example 4 includes the system of example 1, wherein

the cloud resource appears in a graphical blueprint canvas that allows for drag and drop creation of the blueprint.

Example 5 includes the system of example 1, wherein the programmable circuitry is to receive a provisioning request from the blueprint service to provision the cloud resource.

Example 6 includes the system of example 1, wherein the programmable circuitry is to expose an API for entry of new resource capabilities in the first format.

Example 7 includes the system of example 1, wherein the metadata includes a schema for the cloud resource.

Example 8 includes a non-transitory computer readable storage medium comprising instructions which, when executed by programmable circuitry, cause the programmable circuitry to retrieve metadata associated with a plugin for a cloud resource platform, the plugin to provide a capability to provision a cloud resource of the cloud resource platform, perform a first transformation of the metadata from a first format associated with the plugin to a second format associated with a blueprint service, register the capability into the blueprint service, generate a blueprint including instructions to provision the cloud resource, transform the blueprint from the second format to a third format, the third format at least partially defined by the first format, and provision the cloud resource based on the transformed blueprint.

Example 9 includes the non-transitory computer

readable storage medium of example 8, wherein the programmable circuitry is to retrieve the metadata via an API call at periodic intervals to obtain new versions of the plugin.

Example 10 includes the non-transitory computer readable storage medium of example 8, wherein the first transformation is a javascript object notation (JSON) to JSON transformation.

Example 11 includes the non-transitory computer readable storage medium of example 8, wherein the cloud resource appears in a graphical blueprint canvas that allows for drag and drop creation of the blueprint.

Example 12 includes the non-transitory computer readable storage medium of example 8, wherein the programmable circuitry is to receive a provisioning request from the blueprint service to provision the cloud resource.

Example 13 includes the non-transitory computer readable storage medium of example 8, wherein the programmable circuitry is to expose an API for entry of new resource capabilities in the first format.

Example 14 includes the non-transitory computer readable storage medium of example 8, wherein the metadata includes a schema for the cloud resource.

Example 15 includes a method comprising retrieving, by executing an instruction with processor circuitry, metadata associated with a plugin for a cloud resource platform, the plugin to provide a capability to provision a cloud resource of the cloud resource platform, performing, by executing an instruction with the processor circuitry, a first transformation of the metadata from a first format associated with the plugin to a second format associated with a blueprint service, registering, by executing an instruction with the processor circuitry, the capability into the blueprint service, generating, by executing an instruction with the processor circuitry, a blueprint including instructions to provision the cloud resource, transforming, by executing an instruction with the processor circuitry, the blueprint from the second format to a third format, the third format at least partially defined by the first format, and provisioning, by executing an instruction with the processor circuitry, the cloud resource based on the transformed blueprint.

Example 16 includes the system of example 1, wherein the programmable circuitry is to retrieve the metadata via an API call at periodic intervals to obtain new versions of the plugin.

Example 17 includes the system of example 1, wherein the first transformation is a javascript object notation (JSON) to JSON transformation.

Example 18 includes the system of example 1, wherein the cloud resource appears in a graphical blueprint canvas that allows for drag and drop creation of the blueprint.

Example 19 includes the system of example 1, wherein the programmable circuitry is to receive a provisioning request from the blueprint service to provision the cloud resource.

Example 20 includes the system of example 1, wherein the programmable circuitry is to expose an API for entry of new resource capabilities in the first format.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A system comprising:
interface circuitry;
programmable circuitry; and
instructions to program the programmable circuitry to:
retrieve metadata associated with a plugin for a cloud resource platform, the plugin to provide a capability to provision a cloud resource of the cloud resource platform;
transform the metadata from a first format associated with the plugin to a second format associated with a blueprint service;
register the capability into the blueprint service;
generate a blueprint including instructions to provision the cloud resource;
transform the blueprint from the second format to a third format, the third format at least partially defined by the first format; and
provision the cloud resource based on the transformed blueprint.

2. The system of claim 1, wherein the programmable circuitry is to retrieve the metadata via an API call at periodic intervals to obtain new versions of the plugin.

3. The system of claim 1, wherein the first transformation is a javascript object notation (JSON) to JSON transformation.

4. The system of claim 1, wherein the cloud resource appears in a graphical blueprint canvas that allows for drag and drop creation of the blueprint.

5. The system of claim 1, wherein the programmable circuitry is to receive a provisioning request from the blueprint service to provision the cloud resource.

6. The system of claim 1, wherein the programmable circuitry is to expose an API for entry of new resource capabilities in the first format.

7. The system of claim 1, wherein the metadata includes a schema for the cloud resource.

8. A non-transitory computer readable storage medium comprising instructions which, when executed by programmable circuitry, cause the programmable circuitry to:
retrieve metadata associated with a plugin for a cloud resource platform, the plugin to provide a capability to provision a cloud resource of the cloud resource platform;
perform a first transformation of the metadata from a first format associated with the plugin to a second format associated with a blueprint service;
register the capability into the blueprint service;
generate a blueprint including instructions to provision the cloud resource;
transform the blueprint from the second format to a third format, the third format at least partially defined by the first format; and
provision the cloud resource based on the transformed blueprint.

9. The non-transitory computer readable storage medium of claim 8, wherein the programmable circuitry is to retrieve the metadata via an API call at periodic intervals to obtain new versions of the plugin.

10. The non-transitory computer readable storage medium of claim 8, wherein the first transformation is a javascript object notation (JSON) to JSON transformation.

11. The non-transitory computer readable storage medium of claim 8, wherein the cloud resource appears in a graphical blueprint canvas that allows for drag and drop creation of the blueprint.

12. The non-transitory computer readable storage medium of claim 8, wherein the programmable circuitry is to receive a provisioning request from the blueprint service to provision the cloud resource.

13. The non-transitory computer readable storage medium of claim 8, wherein the programmable circuitry is to expose an API for entry of new resource capabilities in the first format.

14. The non-transitory computer readable storage medium of claim 8, wherein the metadata includes a schema for the cloud resource.

15. A method comprising:
retrieving, by executing an instruction with processor circuitry, metadata associated with a plugin for a cloud resource platform, the plugin to provide a capability to provision a cloud resource of the cloud resource platform;
performing, by executing an instruction with the processor circuitry, a first transformation of the metadata from a first format associated with the plugin to a second format associated with a blueprint service;
registering, by executing an instruction with the processor circuitry, the capability into the blueprint service;
generating, by executing an instruction with the processor circuitry, a blueprint including instructions to provision the cloud resource;
transforming, by executing an instruction with the processor circuitry, the blueprint from the second format to a third format, the third format at least partially defined by the first format; and
provisioning, by executing an instruction with the processor circuitry, the cloud resource based on the transformed blueprint.

16. The system of claim 1, wherein the programmable circuitry is to retrieve the metadata via an API call at periodic intervals to obtain new versions of the plugin.

17. The system of claim 1, wherein the first transformation is a javascript object notation (JSON) to JSON transformation.

18. The system of claim 1, wherein the cloud resource appears in a graphical blueprint canvas that allows for drag and drop creation of the blueprint.

19. The system of claim 1, wherein the programmable circuitry is to receive a provisioning request from the blueprint service to provision the cloud resource.

20. The system of claim 1, wherein the programmable circuitry is to expose an API for entry of new resource capabilities in the first format.
